(19) United States
(12) Patent Application Publication
(10) Pub. No.: US 2008/0312938 A1
(43) Pub. Date: Dec. 18, 2008

(54) Ticket Management System

(76) Inventors: Patrick J. Toole, Rancho Santa Margarita, CA (US); Sudhir Krishnaswamy, Koramangala (IN); Nima Moayedi, Irvine, CA (US); David N. Lord, Agoura Hills, CA (US); Francisco J. Gutierrez, Northridge, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/761,988

(22) Filed: Jun. 12, 2007

(51) Int. Cl. G06Q 10/00

(52) U.S. Cl. 705/1

(57) ABSTRACT

Embodiments of the invention include a system and set of processes for managing tickets. The system maintains a database of tickets belonging to a company and the allotment of the tickets to employees and clients. The system provides interfaces for requesting tickets and managing ticket requests. The system optionally provides automated request processing, ticket resale and purchase and electronic distribution.

### BACKGROUND

1. Field

Embodiments of the invention relate to a method and system for managing a pool of tickets. Specifically, the embodiments relate to a method for managing the allotment of tickets owned by an entity such as a company amongst the employees and clients of the entity.

2. Background

Large and small companies purchase tickets to sporting events, theater, concerts and other special events. These tickets are utilized for a variety of purposes. The tickets are given or discounted to employees as an incentive, to improve morale in the workplace or for business networking purposes. The tickets are also given to or shared with clients or business associates for networking, business building and similar purposes.

These tickets must be tracked and managed by a group of administrators or managers within the company. The managers must organize the purchase, storage and distribution of the tickets. A set of procedures is often applied to the allotment of tickets to clients and employees. The activities related to the management of the tickets are time consuming and can result in some tickets not being allotted, the tickets being inefficiently allotted or the tickets being allotted contrary to the proper application of company procedures or goals.

Often managers record or track the tickets in simple spreadsheets or word processing documents. This process is time consuming and requires that the tickets are manually mailed or delivered to each recipient. Allotment must be managed through email requests or set allotment schemes that are not automated and do not adapt to the needs of the manager or company. If insufficient tickets are available for request, then the request cannot be fulfilled. If an excess number of tickets have been purchased, then there is no easy mechanism for recovering the cost of these tickets.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a search interface for the ticket management system.

FIG. 2 is a flowchart of one embodiment of a process for ticket requesting.

FIG. 3 is a diagram of one embodiment of an interface for viewing a ticket request status.

FIG. 4 is a flowchart of one embodiment of a process for ticket approval.

FIG. 5 is a diagram of one embodiment of an interface for ticket approval.

FIG. 6 is a flowchart of one embodiment of a process for automated request processing.

FIG. 7 is a diagram of one embodiment of an interface for editing proxy information.

FIG. 8 is a diagram of one embodiment of an interface for order fulfillment.

FIG. 9 is a flowchart of one embodiment of a process for ticket order fulfillment.

FIG. 10 is a diagram of one embodiment of an interface of a concierge service.

FIG. 11 is a flowchart of one embodiment of a process for ticket redistribution.

FIG. 12 is a diagram of one embodiment of an interface for ticket distribution.

FIG. 13 is a flowchart of one embodiment of a ticket distribution process.

FIG. 14 is a diagram of one embodiment of an interface for report generation.

FIG. 15 is a diagram of one embodiment of a system for managing tickets.

### DETAILED DESCRIPTION

In the following description, for the purpose of explanation, numerous specific details are set forth to provide a thorough understanding of the various embodiments. It will be apparent to one of ordinary skill in the art that the embodiments may be practiced without some of these specific details. In other instances, certain structures and devices are omitted or simplified to avoid obscuring the details of the various embodiments.

The following description and the accompanying drawings provide examples for the purposes of illustration. However, these examples should not be construed in a limiting sense as they are not intended to provide an exhaustive list of all possible implementations.

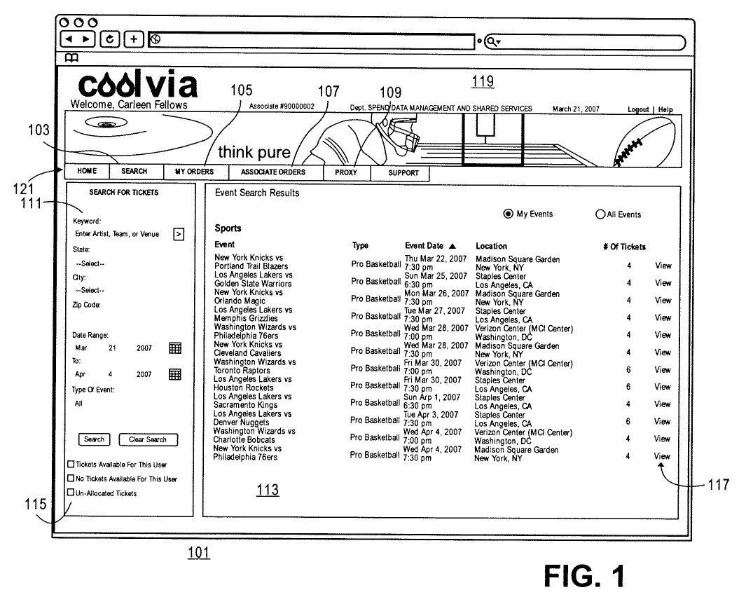

FIG. 1 is a diagram of one embodiment of a search interface for the ticket management system. In one embodiment, the ticket management system provides an interface for searching 101 the tickets that belong to a company, government agency, non-profit or similar organization or group of individuals. For sake of clarity, an example of a company is provided herein. One skilled in the art would understand that the principles and concepts described in relation to a company would be applicable to other entities.

In one embodiment, the ticket management system is administered and hosted by a separate entity from the company, referred to herein as a ticket management provider. The ticket management provider can offer the ticket management system to a set of customers who subscribe to the system as a service. As used herein, a set may refer to any positive whole number of items including one item. In another embodiment, the ticket management system is administered and hosted by the company itself.

Tickets available through the ticket management system may be sport events tickets, such as baseball and football games, concerts, theater, cinema, conferences, and similar types of events and venues. Other similar resources may be managed by the system such as dub memberships, vehicles and similar resources. For sake of clarity the example of tickets are provided herein. A company can hold any number and variety of tickets. The company can also have relationships with other entities to share or pool tickets or to offer tickets to one another under defined circumstances. For example, tickets displayed through the search interface can belong to another subscriber to the ticket management system, a second party such as the ticket management provider, a third party, such as a ticket reseller or a ticket vender. The tickets of other subscribers are listed at the request or instruction of the controlling subscriber. This is done to avoid the loss in investment of an unused ticket by offering it for sale to other subscribers. The second and third parties can also offer tickets for resale and the system can also support the direct purchase from the original vendor or any intermediate party. The tickets available from other sources can be made available through the search interface or the concierge interface, each of which are described below.

In one embodiment, the set of tickets held by a company is tracked in a database. The database stores information about each ticket, including its venue, cost, date, time, description, access restrictions and similar information. A set of business rules can also be associated with each ticket that defines the level or type of user that can request a ticket or the conditions under which the ticket is allotted or redistributed outside the company. These business rules can also be applied to second party, third party and vendor tickets. Any number of related data items can be stored for each ticket. The company can designate the associated data and data fields that are to be tracked.

The search interface 101 is a part of a larger website that is hosted by the ticket management provider and provides other ticket management services. The website can be navigated through a navigation interface 121. The navigation interface 121 provides navigation options for the search interface 103, user orders 105, associate orders 107 or orders to be reviewed, proxy settings 109, user support and similar navigation options. The navigation options available to a particular user vary dependent on the role and permission levels of the user. The entire website is provided by the ticket management provider or the company itself. In the embodiment where a ticket management provider hosts the website, the website can be branded 119 and specialized for the company. A brand 119 can also link the interfaces of the ticket management system to the corporate website. In a further embodiment, the aspects of the ticket management system hosted by the ticket management provider are integrated into the larger company website that is hosted by the company or another entity.

The search interface 101 includes a search criteria input section 111. The search criteria input section 111 includes user interface elements such as drop down menus, text fields, calendars and similar mechanisms to allow a user to specify the criteria for searching the database of tickets to find a desired set of tickets. In one example embodiment, the search criteria input section 111 includes user interface elements for specifying a keyword, an address including state, city, street number and zip code, a date, a time, event type and similar search criteria options.

In one embodiment, the search criteria input section 111 also allows a user to specify a time and date range within which events are to be searched. The time and date range are specified by selection of a specific start day and time, days of the week, time of day or similar date and time criteria. The time and date range can be specified through text boxes, drop down menus or pop-up calendars.

A legend 115 is displayed in the search criteria input section 111 or other sections of the search interface 101. The legend 115 indicates information about a listing of available tickets that meet the provided search criteria. The legend indicates a color coding or similar indicators that identify tickets that are available for the user, allocated for the user, not available or similar information about the tickets.

The search results section 113 displays the tickets that meet the search criteria of a user or related criteria. The results provide a description of each event, the type of the event, date and time, location, number of tickets or similar information. Additional information can be accessed through a ‘view’ link 117 or similar mechanism. The additional information is presented as a pop-up, another webpage or through a similar interface mechanism. More specific information is provided such as ticket location, parking information, guest lists, venue information, and similar information through this link.

The search results can be further sorted or filtered. The search results section 113 provides user interface options to affect further sorting and filtering. The order of the search results can be sorted on each column and the results filtered to those that are specifically available to the user or similar sorting and filtering options may be provided.

The user selects any of the displayed search results through the search result section 113 or through the more detailed view 117. The user is forwarded to a ticket request interface that requires the user to provide information relating to the request including business justifications, guest lists indicating who is to use each ticket and similar information. This information is then submitted to the ticket management system for approval.

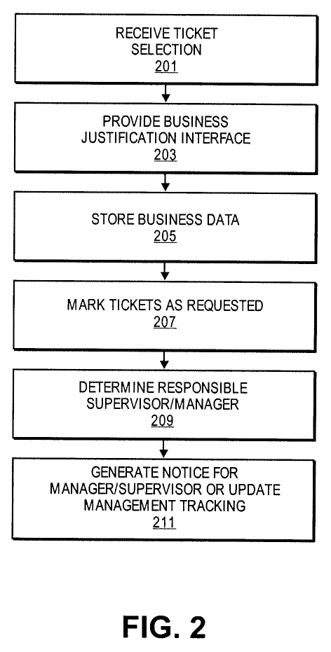

FIG. 2 is a flowchart of one embodiment of a process for ticket requesting. The system receives requests for tickets from the users of the system. The users of the system are employees, clients, managers, executives and similar individuals. Each individual or class of individuals can be given a different user level or role that restricts the options available to them through the interfaces of the ticket management system. Executives, managers or other types of users can be given approval and proxy setting powers that average users do not have. Also, executives, managers or other types of users can be given access to a larger or more varied supply of tickets to be requested and viewed.

In one embodiment, the process of managing ticket requests is initiated by receiving a ticket selection from a user (block 201). The user selection is received from a search interface or similar source. The ticket selection information includes identifying information about the requested tickets including the event information, requesting user information, number of tickets, placement of tickets, delivery options and similar information related to the request for the allotment of tickets to the user.

The ticket management system responds by providing a business justification interface to allow the user to input business justification information and details (block 203). The business justification details obtained through the business justification interface include a guest list specifying each individual that will receive a requested ticket, information about the purpose of the allotment, such as a gift to a client, and similar information that is relevant to the decision making process for approving the allotment. The business justification information is stored in the database or similar data store (block 205). This data is subsequently retrieved during the review of the request to determine whether an allotment is to be approved.

The tickets that are selected in the request are marked or tracked in the database (block 207). The tickets are marked as temporarily unavailable to prevent more than one user from requesting the same tickets. The responsible supervisor or approving authority is then determined (block 209). The responsible supervisor can be a manager of an employee making a request, a designated officer of the company, administrator of the ticket management system or any other user of the ticket management system. The responsible supervisor is stored in a database of the ticket management system that specifies the supervisor information for each user. If the user is not known or does not have a designated supervisor, such as a client of the company or similar entity, then a default, designated supervisor or ticket master that loaded the tickets into the system is selected. In one embodiment, an indicator or tracking mechanism is updated to record that the supervisor has a pending request. In another embodiment, a message or similar notice is generated and sent to the supervisor account to initiate the review of the request (block 211).

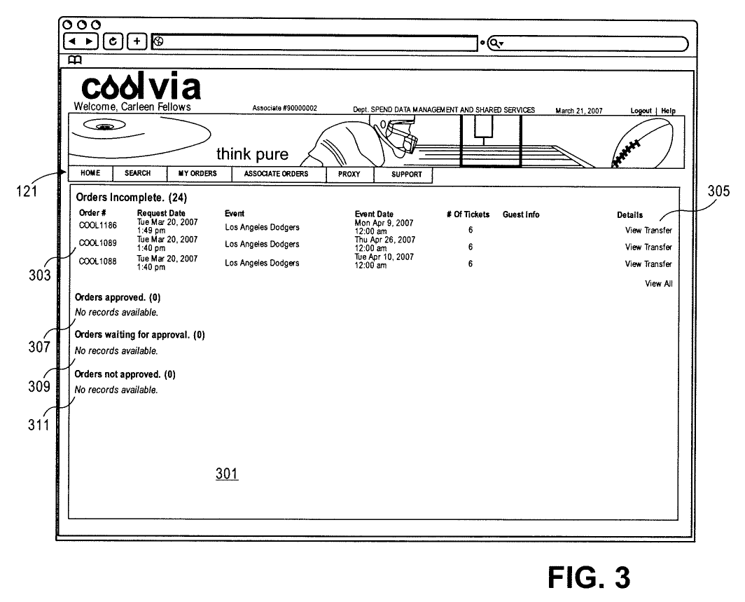

FIG. 3 is a diagram of one embodiment of an interface for ticket request status. In one embodiment, each user can view the pending requests or other types of information through an order interface 301. The order interface 301 can be accessed through the navigation interface 121. The order interface 301 lists incomplete orders 303, approved orders 307, orders awaiting approval 309, denied orders 311 and similar order information associated with the user. Incomplete orders 303 include orders that have been approved, but that have not yet been fulfilled.

Information provided about each order may include the order number, request date, event description, event data and time, number of requested tickets and similar information. Requests that have been denied are listed accordingly and include an explanation for the reasons for denial or information about a rule from an automated process that was not satisfied. The information can further include a link to more detailed information about each request.

A transfer link 305 is also provided that facilitates the transfer of tickets to another user. After a request for tickets has been approved, a user can use the transfer link 305 to reassign the tickets to another user. Tickets that have not been approved cannot be reassigned. A request to reassign can automatically be carried out or in the alternative can be sent to a supervisor or ticket manager for evaluation or allotment. The supervisor can approve the transfer in the same manner that ticket allotment is reviewed and processed.

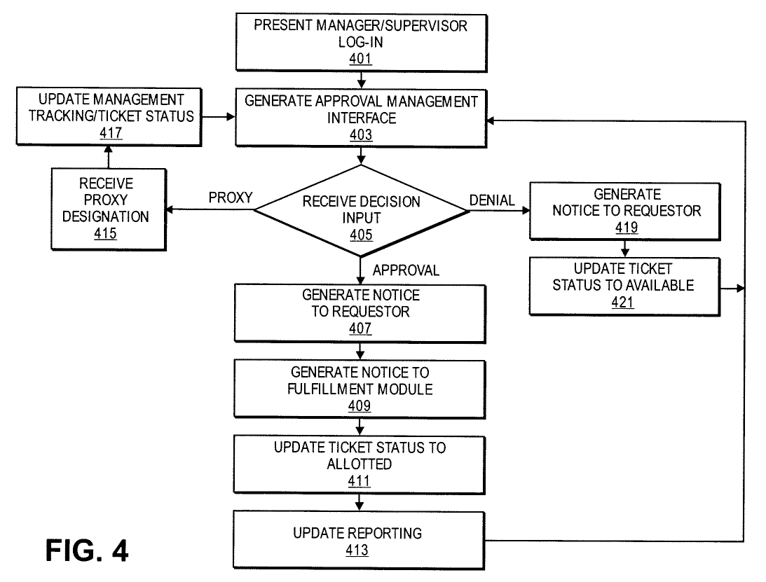

FIG. 4 is a flowchart of one embodiment of a process for ticket approval. In one embodiment, the process for ticket request approval is initiated at the log in of a supervisor or similar individual with an account that is designated to manage the approval of requests from other accounts (block 401). The log-in process requires the user to provide a username and password to access their account. Any type of security protocols or mechanisms can be used to restrict access to each respective user account to prevent unauthorized allotment of tickets. The ticket approval process is executed by the approval management interface module or similar modules.

Upon log-in or upon access to the approval interface an approval management interface is generated and provided to the user (block 403). The features and organization of the approval management interface vary and are described in greater detail below. The approval management interface presents the user with each request that has been received or marked to be reviewed by the user. The user can select each request individually or by a grouping of requests based on the type of request, user making the request or similar criteria. A user can review the business justification data associated with each request before making a decision.

If the user designates a request or set of requests for denial, then the approval management process generates a notice to each requestor (block 419). The notice may be a message or update of a tracking mechanism or database. When each of the requesting users next log into the ticket management system each will see that their request has been moved to the denied request or order section of their order interface. In addition, an email, text message or similar message can be sent to the user to notify them of the denial or that new information is available to them through the ticket management system.

The status of each of the requested tickets that are associated with the denied requests is then updated (block 421). The status is updated to indicate that the tickets are available to users with the appropriate user type or level or similar characteristics. The approval management system then becomes available for further input and decisions from the user (block 405).

The user can select any number of the requests to be approved. If a request is approved, then a notice to the requester is generated (block 407). The notice can be a message or update of a tracking mechanism or database. When each of the requesting users next log into the ticket management system, each of the users will see that their request has been moved to the approved request or order section of their order interface. In addition an email, text message or similar message can be sent to the user to notify them of the approval or that new information is available to them through the ticket management system.

A message or notice is sent to a fulfillment system (block 409). The fulfillment system can be another component of the ticket management system or an external system or entity. For example, if the tickets are to be distributed digitally, then the fulfillment system may be a module of the ticket management system that automatically generates and sends the electronic tickets to the requestor. If the fulfillment system belongs to a second, third party or vendor, then a message is sent to that system to initiate the fulfillment process by the mailing of the tickets or similar delivery of the tickets to the requester.

The status of the approved tickets that are associated with the approved requests are then updated (block 411). The status is updated to indicate that the tickets are allotted to a specific user. If a reporting or accounting system is integrated or interoperable with the ticket management system, then a notice or update is sent to that system (block 413). The accounting or reporting system is provided with the details and costs involved in the approved request. This data can be used to generate expense reports, analyze operating costs and provide similar information. The approval management system then becomes available for further input and decisions from the user (block 403).

The user can select any number of the requests to designate to be handled by a proxy. The proxy designation is received by the ticket management system and can be stored or added to the proxy preferences for the user (block 415). A message or update of the tracking system database or similar mechanism is processed to notify the designated proxy that a request is awaiting their approval. The request is available to the proxy through their approval management interface when they next log in or if they are currently logged in. The request tracking mechanism or ticket status tracking mechanism, e.g., the ticket database, is updated to reflect that the requested tickets and the associated request have been designated for review by a proxy (block 421). After the relevant tracking of the ticket is updated and the request is forwarded or copied to the proxy, then the approval interface becomes available for further input (block 403).

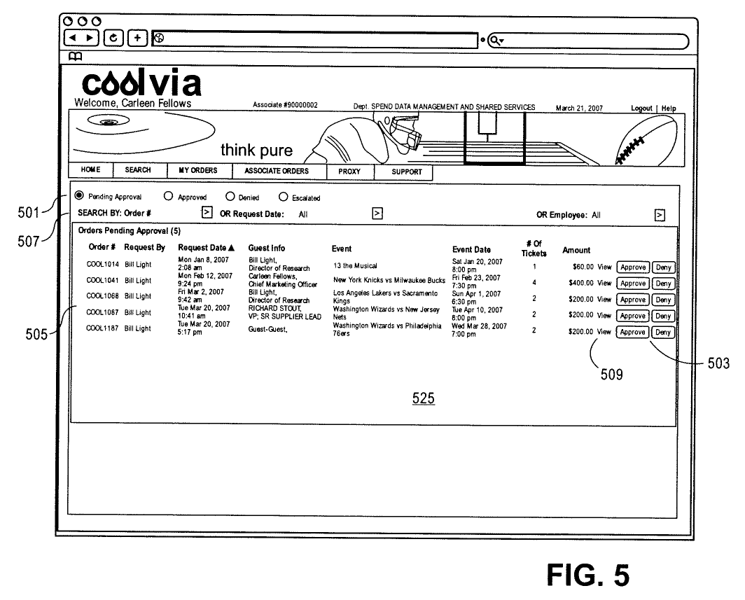

FIG. 5 is a diagram of one embodiment of an interface for ticket approval. The approval management interface 525 provides the user with information about each of the requests pending approval 505. The information may include order number, requestor information, guest information, event description, event date and time, number of tickets, cost or amount of the tickets and similar information. A link may be provided to view additional information 509. The additional information is displayed through a pop up, another window or similar interface mechanism. User interface options, such as buttons, are provided to allow the user to approve or deny the request. Similar options can be provided for forwarding or transferring the requests to a proxy. The approval management interface 525 is provided by an approval management interface module.

The approval management interface 525 also provides search tools 507 to find specific requests if a large number of requests have been received making it difficult to display all of them at the same time or find a specific request. Search tools 507 include a text field or similar user interface mechanism to search for order numbers, keywords, events, guests, dates, requester or similar information related to the request. These fields can also be searched or filtered through drop down menus or similar user interface mechanisms. The requests can be filtered or sorted into pending approval, approved, denied or escalated. Escalated indicates that the request was forwarded to a higher supervisor or more senior user or decision maker.

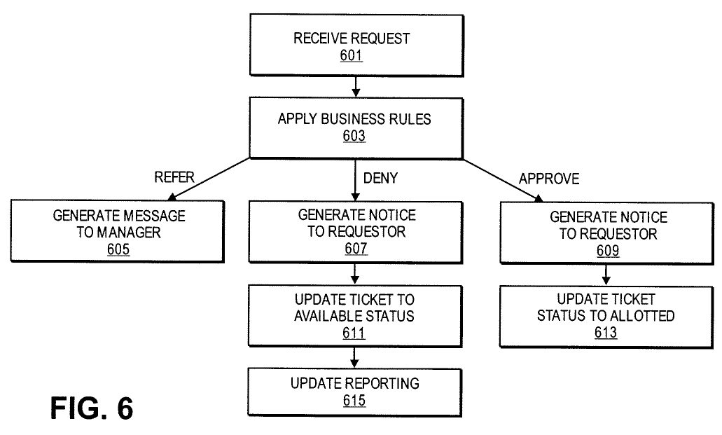

FIG. 6 is a flowchart of one embodiment of a process for automated request processing. In place of or at the initiation of a supervisor or manager an automated approval process can be executed to handle pending requests. The automated process can be configured to evaluate requests based on any criteria, values or weighting of factors. The automated approval process is executed by a business rules module or similar component of the system.

The automated process is initiated by forwarding a request to the automated request account or module (block 601). The automated approval process can apply any set of business rules to the request to evaluate the request. These rules are specified by an administrator of the ticket management system, a ticket manager, a supervisor or similar user. For example, the approval process may limit the number of tickets or requests for a user in a calendar year, require that at least one client is listed in the guest list, restrict the total cost of any request or similarly analyze each of the requests (block 603).

The automated process determines whether the specified criteria are met, generates a score for the request and determines if specified threshold score is met or determines whether the requirements of a similar algorithm are satisfied. If the automated process is satisfied, then a request is approved. A notice is generated to inform the requestor that the request has been approved or that there is information for the requestor to review in the automated ticket management system (block 609). The status of the tickets in the request are updated to reflect their allotment (block 613). Internal or external reporting or similar software is updated with the allotment information (block 615).

If the automated process determines that a request is to be denied, then a notice is generated to inform the requestor that the request has been denied or that there is information for the requestor to review in the automated ticket management system (block 607). The status of the tickets in the request are updated to reflect that they are available again (block 611). Internal or external reporting software or similar software is updated with denial information (block 615).

If the automated process cannot come to a decision or an error condition occurs, then the request is referred to a ticket manager or supervisor. A message is generated to the ticket manager or supervisor (block 605). The message can be a text message, electronic mail message, automated phone message or similar message notifying the ticket manager or supervisor of the error or referral.

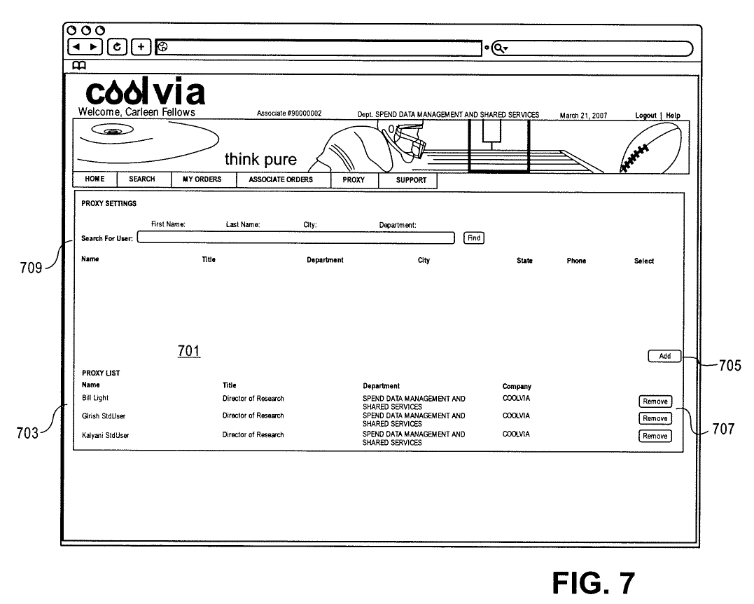

FIG. 7 is a diagram of one embodiment of an interface for editing proxy information. A proxy interface 701 can be reached from the navigation interface 121 or similar navigation options. The proxy interface 701 allows a user to designate a set of individuals with proxy authority to make approval or denial decisions for user requests for allotment of tickets. Each of the designated proxies may automatically receive requests or copies of requests that the designated user has authority over or they may be options for forwarding requests to. The proxy interface 701 is provided by a proxy interface module.

The proxy interface 701 presents a list of proxies 703 and a search interface 709 for finding an individual to designate as a proxy. The list of proxies 703 includes information about each proxy including name, title, department, company and similar information. An option 707 is also presented to allow for the removal of the proxy. The search interface 709 includes fields to allow for searches for individuals based on their first, middle and last name, address or city, department, state, phone or similar information. Results of searches are displayed and any number of individuals can be selected to be added as proxies.

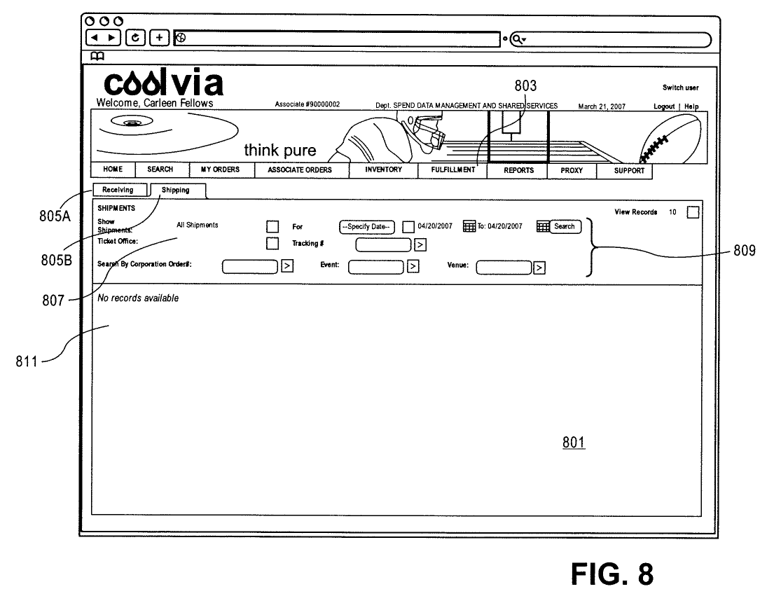

FIG. 8 is a diagram of one embodiment of an interface for order fulfillment. The order fulfillment interface 801 may be accessed from the navigation interface through a navigation option 803. This navigation option 803 can have a restricted access based on the role or permission level of a user. For example, access to this navigation option 803 and interface 801 can be restricted to a ticket manager, who has responsibility for fulfilling internal requests for tickets or a subset of the internal requests.

In one embodiment, the interface 801 separates fulfillment orders into those being received (i.e., purchases of tickets) and those being shipped (i.e., those tickets having an approved allotment). Each set of orders are placed into different tabs 805A, 805B for convenience of management and viewing. The orders can be further sorted based on the types of shipments 807. Any type of user interface mechanism can be utilized to allow selection and filtering based on the type of shipments to be viewed. Shipments can be filtered based on categories including shipped, confirmed, waiting for pickup, unprocessed, ready to ship, in-transit, delivered, will call or similar categories. In another embodiment, the orders are grouped or viewable together or the categories or filters are separately tabbed or similarly organized.

Additional search and filtering features 809 are also presented using any type of appropriate user interface mechanism. Additional search and filtering features 809 can include any combination of a date or date range, ticket office, external tracking number, internal corporate order number, event, venue, location, requester, guest or similar data or criteria available to filter or search the available purchase or fulfillment orders.

The fulfillment interface 801 also includes a record display section 811. In this section records that meet the specified filter or search criteria are displayed. Details of the orders to be fulfilled are displayed in this section 811. Any number of orders can be displayed at one time. Additional details can be made available through links provided in the record display section 811.

The fulfillment interface 801 can be provided by a fulfillment module or similar component of the ticket management system. The fulfillment interface 801 can also provide settings and rule input interfaces to allow a ticket manager or system administrator to configure automated fulfillment procedures.

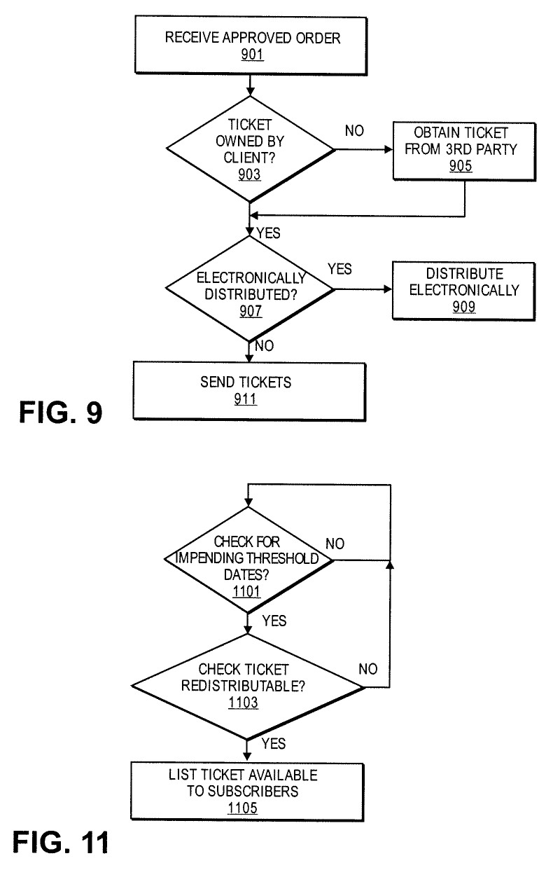

FIG. 9 is a flowchart of one embodiment of a process for ticket order fulfillment. In one embodiment, a ticket fulfillment process is executed by a ticket fulfillment module. The ticket fulfillment process provides an allotted ticket to the appropriate requester after approval.

In one embodiment, this process is initiated when an approved order is forwarded to the fulfillment module (block 901). The approval order is automatically forwarded and includes identifying information about the allotted tickets. In another embodiment, the fulfillment module retrieves the identifying information from the ticket database.

A check is made to determine if the identified tickets are owned by the company (block 903). A ticket can be available and allotted that is not owned by the company. For example, a ticket can be requested that is from another subscriber that has not allotted the ticket and is redistributing the ticket or the ticket can be from a vendor or a second or third party reseller.

If the ticket is not owned by the company, then the order is forwarded to the vendor, second or third party ticket holder (block 905). The order can be forwarded electronically or through other methods of communication. The vendor, second or third party then completes the fulfillment by sending the ticket to the requester. The information forwarded to the vendor, second or third party provides information about the destination or requester to allow the vendor, second or third party to fulfill the order.

A check is made to determine if the ticket is electronically distributable (block 907). A ticket can be distributed electronically by displaying it through a web browser to be printed by the recipient or similarly printed by the recipient (block 909). In one embodiment, the ticket is emailed to the requester or a link to a web site providing the ticket is sent to the requester.

If the tickets are not electronically distributable, then the request is serviced by sending the tickets by mail, courier or similar delivery service (block 911). The requester can specify the method, timing and location for delivery. This can be set by a profile of the requester, through the requesting process, after the approval process or similarly determined. The fulfillment of the tickets from within the company is managed through the fulfillment interface, which provides the ticket master with a convenient interface for determining which requests have been fulfilled and which requests need to be fulfilled as well as to track the status of the fulfillment.

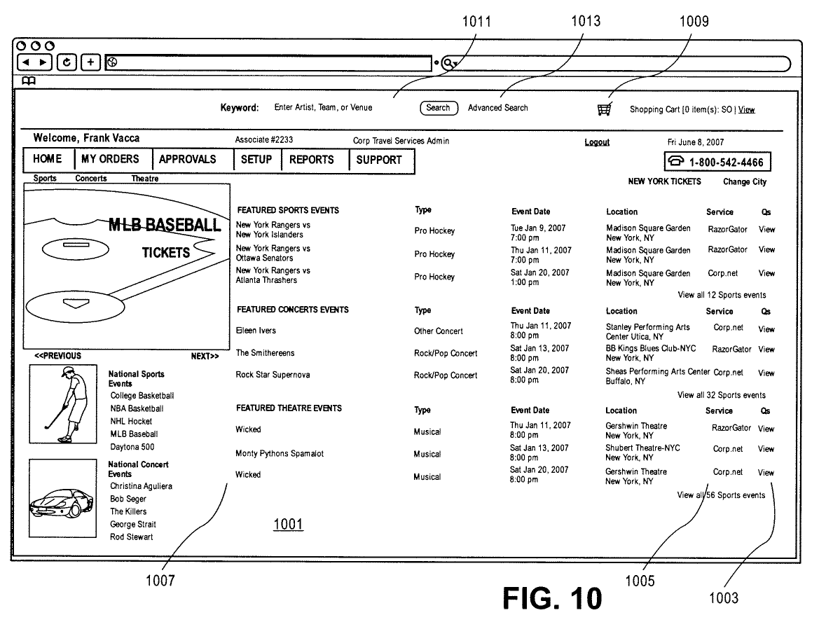

FIG. 10 is a diagram of one embodiment of an interface of a concierge service. In one embodiment, the system provides a concierge interface 1001 to allow employees and others in an organization such as a corporation to purchase or request tickets that do not belong to the organization. These tickets are made available through second parties, such as the ticket system provider, third party vendors, the original vendors and similar entities through the concierge interface 1001. Tickets can be requested for organizational uses or purchased for personal use through the concierge interface 1001. The requests for tickets for both personal and business uses can be managed through the interfaces such as the approval interface, business justification interface, fulfillment interfaces and similar interfaces described herein. In another embodiment, only the tickets for business use are managed within the ticket management system.

A home or main page of the concierge interface 1001 can display featured or upcoming events that may be of interest to the user. The user can obtain further information including options for purchase through a view option 1003. Tickets can also be found through a search interface 1011. The search interface 1011 allows a user to find tickets based on artist, team, venue, dates or similar criteria. Additional search options are available through an advanced search option 1013.

Tickets offered through the concierge interface 1001 are available through external sources. In one embodiment, these sources are identified by a source field 1005. The source field identifies the first, second or third party offering the tickets for sale. For example, the tickets can be offered by a corporate network that allows member companies to sell tickets that have not been allotted internally by a company that subscribes to the corporate network resale service provided by the ticket management provider.

FIG. 11 is a flowchart of one embodiment of a process for ticket redistribution. A company may not be able to allot all of the tickets that it has purchased or controls. In this case, the company is likely to lose its investment in the tickets. To avoid this loss of investment, the company can offer them for sale to other companies. This service is offered through the ticket management provider. The ticket management provider offers the ticket management service to any number of subscriber companies. The tickets that any company that subscribes to the service cannot use are automatically offered to the other companies. The tickets are made available to other companies through the search interface or concierge interface of the ticket management system. These tickets are displayed when matching search criteria are entered or are advertised or featured for resale through these interfaces.

In one embodiment, the process of determining which tickets to offer to other subscribers is configured to check each of the expiration dates of the tickets held by a company periodically (block 1101). An expiration date can be configured to be any date preceding the event date. For example, a company can set an expiration date for a week in advance of the event date. If a ticket with an expiration date is found, then a check can be made to determine whether the ticket is redistributable (block 1103). Any ticket may be specifically designated as not being redistributable by a company. A ticket may be designated as not redistributable if it is undesirable for the company to redistribute the ticket. For example, tickets tied to a luxury box held by a company or similar tickets can be designated as not being redistributable. A set of criteria can also be defined to determine which tickets are redistributable. Any criteria can be configured in this manner.

If a ticket is not redistributable, then the ticket is retained and the process continues to check other tickets for possible redistribution. If the ticket is redistributable, then the redistribution process marks the ticket as available to subscribers or generates a notice to the ticket management system or administrator (block 1105). In one embodiment, a data field or variable in the data base is an entry associated with the ticket that can be set to indicate the availability of the ticket to subscribers. In one embodiment, an officer (supervisor), employee, ticket manager or administrator of the company is sent a message or similarly notified that a ticket is being made available for redistribution. The company can stop or deny redistribution or similarly manage the redistribution requests.

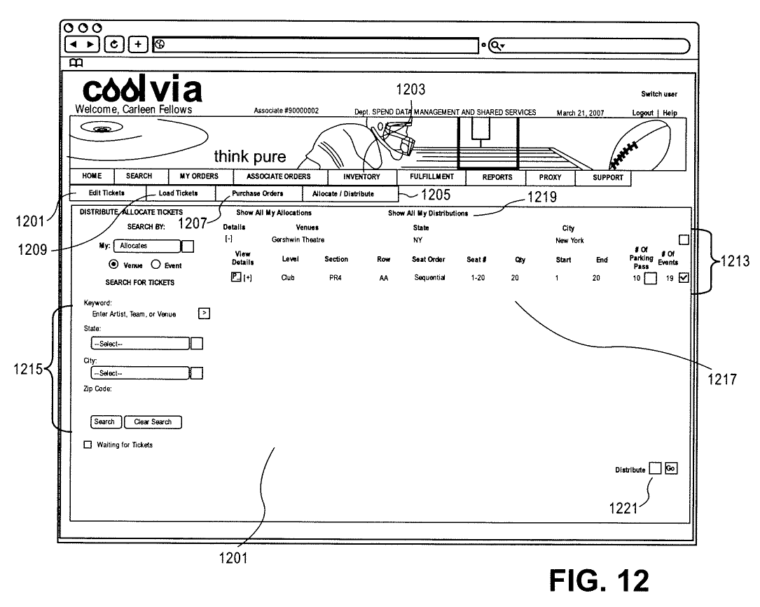

FIG. 12 is a diagram of one embodiment of an interface for ticket distribution and inventory management. The ticket distribution interface 1201 allows a ticket manager or similar user to distribute tickets for eventual allotment. As used herein, distribution is the process of disseminating authority over tickets to decision makers, such as supervisors or managers, or making the tickets available for allotment. Allotment, as used herein, is the assignment of tickets to a set of individuals for use.

The ticket distribution interface 1201 can be restricted to specific users such as the ticket manager who has been given authority over the distribution or management of an organization's tickets or a subset thereof. The ticket distribution interface 1201 can be reached through the navigation interface through a navigation option 1203. The ticket distribution interface 1201 can be further organized into a set of tabs or similar subsections. The ticket distribution interface 1201 can be used to access an editing interface 1211, ticket loading interface 1209, purchase order interface 1207, distribution and allocation interface 1205 or similar subsections.

The editing interface 1211 can be used to inspect the detailed information of each ticket or a group of related tickets and alter the information associated with each ticket. The information that can be viewed and modified include the ticket category, location information, quantity, cost, surcharges, type, ticket office, status, event date, parking information, notes and similar information. Any user interface mechanisms can be used to display and provide the editing tools for modifying the ticket information.

The load ticket interface 1209 allows the ticket manager to add new tickets into the system for distribution and allotment. The new tickets can be added manually or their data can be imported from other electronic ticket data sources or systems. The input data is stored in the ticket database and becomes visible to other users after distribution.

The purchase order interface 1207 can be utilized to input or view data related to the purchase orders associated with obtaining the new tickets. The purchase order information can be used to track the costs and similar information related to the usage of tickets within the ticket management system.

The allocation/distribution interface 1205 allows the ticket manager to view tickets that have been loaded into the system and make decisions about the allotment and distribution of these tickets. This interface 1205 displays selected sets of tickets and allows the ticket manager to make distribution decisions regarding these tickets. The tickets to be distributed can be searched or filtered. A search interface 1215 provides the ticket manager with the ability to search for undistributed tickets based on the keywords, such as artists, teams or venues, venue location and similar criteria. Tickets that meet the selected criteria are displayed in a ticket viewing area 1217. Other filtering and selection interfaces and tools can be provided such as categorized tabs 1219 and similar options.

The ticket manager can select tickets for distribution through the ticket viewing area 1217 including selecting subsets of displayed ticket. Tickets may be selected by groups, specifying ranges and similar techniques. The selected tickets can be designated for distribution through a distribution button 1221 or similar user interface mechanism. The distribution designation starts an interactive process to determine the destination of the tickets. This interactive process can be partially or entirely automated by application of predetermined distribution rules or distribution trees that designate the individuals that tickets with specified characteristics are to be distributed to. The process can also be directly managed by the ticket manager and provide tools for this process such as an employee search tool to find the employee designated to handle the next level of distribution.

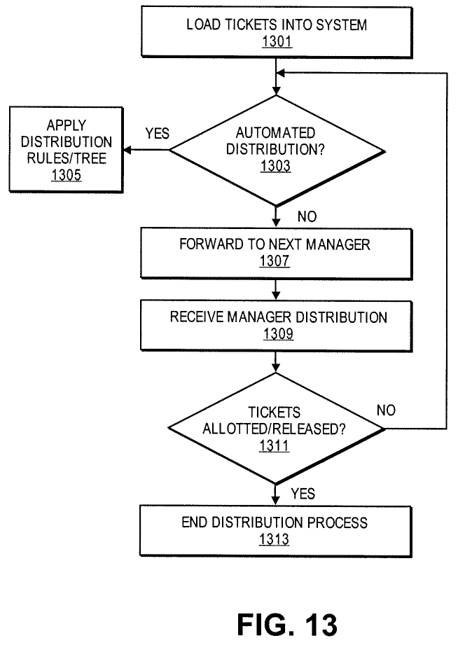

FIG. 13 is a flowchart of one embodiment of a ticket distribution process. In one embodiment, this process can be partially or entirely automated at the initiation of a ticket manager or upon the loading of tickets into the system (block 1301). Tickets can be added or loaded into the system manually or by electronic data transfer. This process can be carried out by a ticket manager or similar user. The loading of tickets into the system can also be accompanied by other data including purchase order, invoicing and similar data.

A check can be made by the system to determine upon input of the ticket data whether the loaded tickets are to be automatically distributed (block 1303). The ticket manager may designate the tickets for automatic distribution during the loading process or the tickets can be analyzed to determine if they meet specified criteria for automatic distribution. For example, the distribution process can be configured to automatically distribute tickets associated with specific teams, venues or locations.

If the tickets are designated for automatic distribution, a set of predefined distribution rules are applied to forward each of the tickets to the appropriate user account for allotment or into the generally available pool of tickets (block 1305). In one embodiment, any combination of business rules can be defined by system users or administrators to determine the criteria for distributing tickets. For example, a rule can be implemented that designates specific office managers to handle allotment or further distribution of tickets in each of their respective cities. In another embodiment, a simple distribution tree is executed. The distribution tree or similar data structure designates the distribution of a set of tickets that can be defined by any criteria.

If the tickets are not designated for automatic distribution, then they are forwarded for distribution to a designated ticket manager or set of ticket managers (block 1307). The ticket manager receives the tickets (block 1309) and views the new tickets through the distribution interface and determines how each is to be distributed or allotted. If the tickets are allotted or released into the system to be requested by any set of users then the ticket distribution system completes (block 1313). If the tickets are designated for further redistribution then the process continues and checks to determine if the further distribution is automated (block 1303) or the designated manager or user receives these tickets to determine further distribution (block 1307).

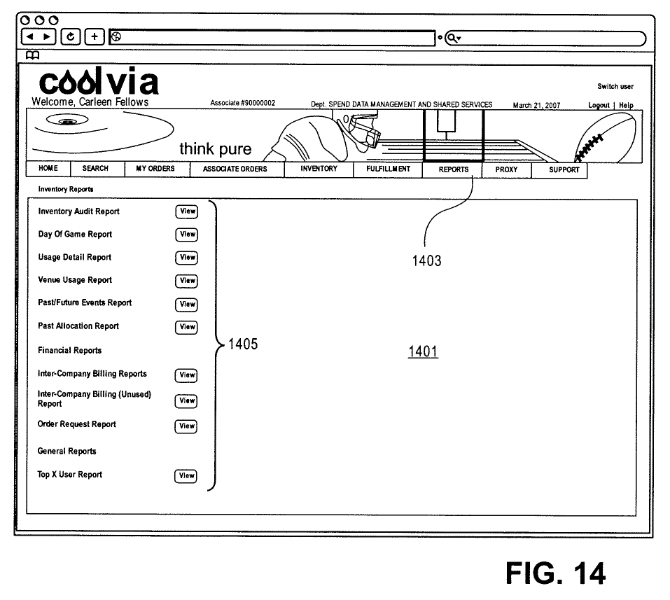

FIG. 14 is a diagram of one embodiment of an interface for report generation. A user with authority or permission to generate a report or set of reports based on information tracked by the ticket management system can access these reports through a report generation interface 1401. The report generation interface can be accessed by users with the appropriate permissions through the navigation interface and a report navigation option 1403 therein.

The report interface 1401 presents a list of reports 1405 available to the user. These reports can be specified or modified by a system administrator or other user with report configuration privileges. Only those reports that a user has permission to view are listed in the interface 1401. The selection of a report from the list 1405 may cause the generation or display of the report. The display and interaction of each report with a user can be configured.

Reports can be generated by the ticket management system or by an external or separate system. For example, financial reporting can be generated by financial reporting software of the company that interfaces with the ticket management system. The report generation interface may interact with the separate software programs or set of software programs to provide reports to the user through the reporting interface 1401.

Displayed reports can also be modifiable. Modified data can be returned to the program providing the report or stored in the ticketing database. The handling of the report data may be secure or similarly restricted based on user roles and permissions.

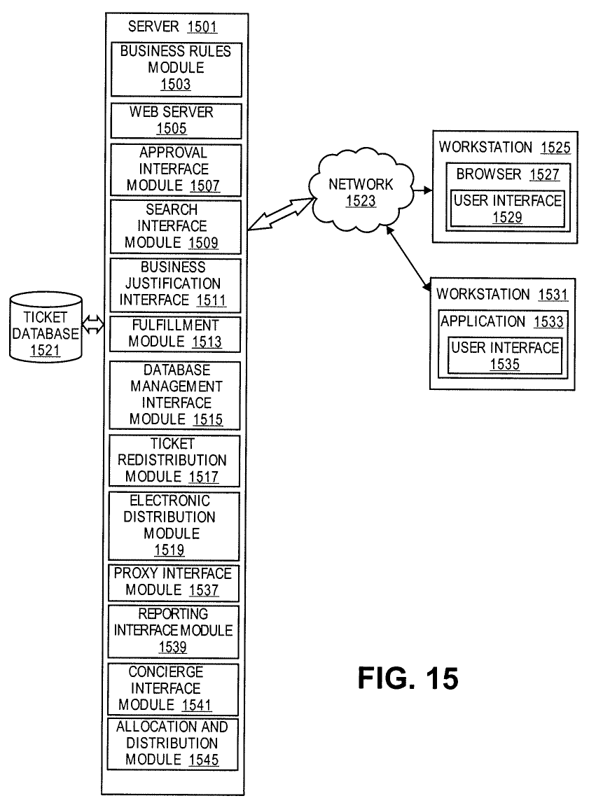

FIG. 15 is a diagram of one embodiment of a system for managing tickets. In one embodiment, the system includes a server 1501 for providing the ticket management system functionality in communication with a database 1521 that stores the persistent data of the ticket management system. Any number of users can access the functionality of the ticket management system through remote or local machines 1525, 1531 over a network 1523. In other embodiments, the functionality of the ticket management system may be distributed over multiple servers and databases. In a further embodiment, access to the ticket management system may be primarily through the server itself. One skilled in the art would understand there are many methods of implementing the ticket management system based on the principles described herein. For sake of clarity the illustrated embodiment is described as an example embodiment.

The ticket database 1521 can be any type of database including a relational database, object oriented database or similar database. The database 1021 can be in direct communication with the server 1501 or remote from the server and accessible over a network. Any number of databases can be used to store the ticket data. In one embodiment, the database is maintained by and at the location of a third party in relation to the companies storing their ticket information within the database. In another embodiment, a company maintains its own database.

The server 1501 can be any type of machine capable of executing a plurality processes and providing access to the ticket management services over a network 1523. Any number of service machines can divide the load amongst themselves to provide the ticket management system. The ticket management system includes modules for applying business rules 1503, a web server 1505, approval interface 1507, search interface 1509, business justification interface 1511, fulfillment module 1513, database management interface 1515, ticket redistribution module 1517, electronic distribution module 1519, reporting interface module 1539, concierge interface module 1541, allocation and distribution module 1543 and similar modules.

The business rules module 1503 includes stored rules for use in automated decision making for requests. This module also includes the algorithms or artificial intelligence for applying these business rules to requests as part of the automated decision making process. This module can be initiated automatically as configured by a system administrator or executed at user direction.

In one embodiment, the server includes a web server 1505 that provides each of the interfaces of the ticket management system to browsers and similar clients accessing the ticket management system. The web server 1505 interacts with each the application modules accessed by the user and generates and updates the user interface presented to the user as a webpage. The user access this webpage through a web browser 1527 or similar application The web server 1505 can be any web server application.

The approval interface 1507, described above, can be a discrete software module or application. The server 1501 may provide an application server middleware upon which this module or application and other applications or modules operate. The search interface 1509, business justification interface 1511, fulfillment module 1513, electronic distribution module 1519, ticket redistribution module 1517, proxy interface 1037, reporting interface module 1539, concierge interface module 1541, allocation and distribution module 1545 and similar modules and applications can also be executed on application server middleware. The functionality of each of these modules is described above.

The database management interface 1515 executes modifications, insertions, deletions and other operations on the ticketing database 1521. Any database management interface 1515 can be utilized in conjunction with the corresponding type of database that is utilized. For example, a relational database management system (RDBMS) or similar system can be utilized. The database management interface 1015 is accessible by each of the other modules to perform any operation required by those applications.

The server 1501 communicates with remote user machines over a network 1523. The network 1523 can be any type of network including a local area network (LAN), wide area network (WAN), such as the Internet or similar networks. The server 1501 can communicate with the remote user machines using any communication protocol including TCP/IP, HTTP and similar protocols.

Users can access the functionality of the ticket management system through either a general purpose application such as a browser 1527 or a specialized application 1535. The browser 1527 and application 1535 can be executed by any workstation 1525, 1531, desktop computer, laptop, handheld, console devices or similar computers. The browser 1527 and application 1535 each provide access to the ticket management system through user interfaces 1529, 1535 that are based on the functionality and interfaces provided by the ticket management system.

In one embodiment, the ticket management system may be implemented partially or entirely as hardware devices, such as application specific integrated circuits (ASICs). In another embodiment, these components may be implemented in software (e.g., microcode, assembly language or higher level languages). These software implementations may be stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the embodiments of the invention have been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

We claim:

1. A method comprising:
tracking a set of tickets belonging to an entity;
receiving a request for an allotment from the set of tickets; and
generating an interface to manage approval of the request for a designated user.

2. The method of claim 1, further comprising:
restricting the interface to the designated user.

3. The method of claim 1, further comprising:
storing a business rationale for the request.

4. The method of claim 1, further comprising:
receiving a designation of a proxy to allow the proxy to approve the request.

5. The method of claim 1, further comprising:
associating the allotment with a requesting user.

6. The method of claim 1, further comprising:
tracking a guest list associated with the allotment.

7. The method of claim 1, further comprising:
presenting a search interface for the set of tickets owned by the entity.

8. The method of claim 7, wherein the search interface presents tickets available for purchase from a ticket broker.

9. A method comprising:
presenting an interface for viewing a set of tickets available to a first client;
receiving a request for a ticket from a user; and
presenting a business justification interface to obtain a guest list from the user.

10. The method of claim 9, further comprising:
presenting the guest list in an approval interface.

11. The method of claim 9, further comprising:
receiving an approval indicator; and
forwarding the request to a fulfillment module.

12. The method of claim 9, further comprising:
determining a ticket from the set of tickets is unallotted; and
presenting the ticket for resale to a second client.

13. The method of claim 9, further comprising:
receiving a designation of a proxy to determine approval for the request.

14. The method of claim 9, further comprising:
applying a set of business rules automatically to determine approval of the request.

15. The method of claim 9, further comprising:
fulfilling an allotment by digital distribution.

16. A machine readable storage medium, having instructions stored therein, which when executed, cause a machine to perform a set of operations comprising:
tracking an allotment of a plurality of tickets belonging to a first client;
tracking a date of expiration for a ticket of the plurality of tickets; and
offering the ticket for sale through a network to a second client in response to determining the ticket is unallotted on the date of expiration.

17. The machine readable storage medium of claim 16, having further instructions stored therein, which when executed cause the machine to perform a set of operations further comprising:
fulfilling a sale of the ticket by digital distribution.

18. The machine readable storage medium of claim 16, wherein the second client is a part of a subscription network.

19. The machine readable storage medium of claim 17, having further instructions stored therein, which when executed cause the machine to perform a set of operations further comprising:
updating an accounting database to reflect the sale.

20. The machine readable storage medium of claim 16, having further instructions stored therein, which when executed cause the machine to perform a set of operations further comprising:
generating a report of ticket allotment and sales.

21. A method comprising:
generating a display of available tickets from any one of a ticket reseller or vendor;
receiving a request for a ticket of any one of the ticket reseller or vendor;
receiving a business justification input for the request; and
forwarding the request to a supervisor for approval

22. The method of claim 21, wherein the ticket reseller is redistributing an unallotted ticket for another entity.

23. The method of claim 21, further comprising:
forwarding an approved request to the reseller or vendor for fulfillment.

24. A machine readable storage medium, having instructions stored therein, which when executed cause a machine to perform a set of operations comprising:
receiving information for a set of tickets; and
forwarding the information automatically to a set of users based on a set of ticket distribution rules.

25. The machine readable storage medium of claim 24, having further instructions stored therein which when executed cause the machine to perform a set of instructions further comprising:
selecting a recipient of the set of tickets automatically based on any one of a location, venue, team or event type of the set of tickets.

26. The machine readable storage medium of claim 24, having further instructions stored therein which when executed cause the machine to perform a set of instructions further comprising:
designating the set of tickets for availability through a ticket management system in response to the set of tickets failing to meet any distribution criteria.
